(19) United States
(12) Patent Application Publication
(10) Pub. No.: US 2017/0201414 A1
(43) Pub. Date: Jul. 13, 2017

(54) COMMUNICATION DEVICE AND METHOD OF CONTROLLING SAME

(71) Applicant: Samsung Electronics Co., Ltd., Gyeonggi-do (KR)

(72) Inventor: Sung-Soo SHIN, Gyeonggi-do (KR)

(21) Appl. No.: 15/351,937

(22) Filed: Nov. 15, 2016

(30) Foreign Application Priority Data
Jan. 13, 2016 (KR) 10-2016-0004319

(51) Int. Cl. H04L 12/24; H04M 1/725

(52) U.S. Cl. CPC H04L 41/0686; H04L 41/069; H04M 1/72522

(57) ABSTRACT

Methods and apparatuses are provided for controlling a communication device. Log information related to a call is stored. It is determined whether the call is abnormally terminated. Information on a cause of call termination is output when the call is abnormally terminated. The call is abnormally terminated when the call termination does not occur through a termination request of a user.

### PRIORITY

This application claims priority under 35 U.S.C. §119(a) to Korean Application Serial No. 10-2016-0004319, which was filed in the Korean Intellectual Property Office on Jan. 13, 2016, the content of which is incorporated herein by reference.

### BACKGROUND

1. Field of the Disclosure

The present disclosure relates generally to a communication device and a method of controlling the same and, more particularly, to a communication device and a method for allowing a user to identify an abnormal call termination.

2. Description of the Related Art

Based on the mobility of a user equipment (UE), or smart phone, for example, and the UE may be located in various types of communication environments (for example, an area having a relatively bad communication environment, such as a shade area).

When a call is abnormally terminated (for example, regardless of an intention of a user of the UE), the UE is typically not able to provide a cause of the termination to the user.

Further, when a call is abnormally terminated, an analysis of the cause of the termination is performed by engineers, such as, for example, a developer of the UE. This analysis results in increased a manufacturing costs for the UE.

### SUMMARY

According to an embodiment of the present disclosure, when a call is abnormally terminated, a method and a communication device are provided that can inform the user of the cause of the call termination.

In accordance with an aspect of the present disclosure, a communication device is provided that includes a transceiver and a processor electrically connected to the transceiver. The processor is configured to store log information related to a call, determine whether the call is abnormally terminated, and output information on a cause of call termination when the call is abnormally terminated. The call is abnormally terminated when the call termination does not occur through a termination request of a user.

In accordance with another aspect of the present disclosure, a method of controlling a communication device is provided. Log information related to a call is stored. It is determined whether the call is abnormally terminated. Information on a cause of call termination is output when the call is abnormally terminated. The call is abnormally terminated when the call termination does not occur through a termination request of a user.

In accordance with another aspect of the present disclosure, a method of controlling a communication device is provided. Log information related to a call established with another communication device is stored. A call termination message is received upon termination of the call. It is determined whether the call was normally terminated from an indicator of the call termination message. At least a portion of the log information related to a cause of call termination is transmitted to a server, when the call was normally terminated. When the call was not normally terminated, information on the cause of the call termination is output and the at least a portion of the log information related to the cause of the call termination is transmitted to the server. The call is normally terminated through a termination request of a user of the communication device or the other communication device.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1A is a diagram illustrating a communication device, according to an embodiment of the present disclosure;

FIG. 1B is a diagram illustrating a UE including the communication device, according to an embodiment of the present disclosure;

FIG. 2 is a diagram illustrating a method of controlling the UE, according to an embodiment of the present disclosure;

FIGS. 3A to 3C are diagrams illustrating an operation in which, when a call is abnormally terminated, a notification message is displayed and information on the cause of the abnormally terminated call is transmitted to the server through the notification message, according to an embodiment of the present disclosure; and

FIG. 4 is a diagram illustrating a method of controlling the UE, according to another embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

As used herein, the expressions “have”, “may have”, “include”, and “may include” refer to the existence of a corresponding feature (e.g., numeral, function, operation, or constituent element, such as a component), and does not exclude the existence of one or more additional features.

Herein, the expressions “A or B”, “at least one of A and B”, and “one or more of A and B” may include all possible combinations of the items listed. For example, the expressions “A or B”, “at least one of A and B”, or “one or more of A and B” refers to all of (1) at least one A, (2) at least one B, or (3) at least one A and at least one B.

The expressions “first” and “second”, as used herein, may modify various components regardless of their order and/or importance, but do not limit the corresponding components. For example, a first user device and a second user device indicate different user devices although both of them are user devices. Additionally, a first element may be referred to as a second element, and similarly, a second element may be referred to as a first element, without departing from the scope of the present disclosure.

When an element (e.g., a first element) is referred to as being operatively or communicatively “connected” or “coupled” to another element (e.g., a second element), it may be directly connected or coupled to the other element or any other element (e.g., a third element) may be disposed between them. In contrast, when an element (e.g., the first element) is referred to as being “directly connected” or “directly coupled” to another element (e.g., the second element), there are no elements disposed between them.

The expression “configured to”, as used herein, may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “control module adapted (or configured) to perform A, B, and C” may mean a dedicated control module (e.g., embedded control module) only for performing the corresponding operations, or a generic-purpose control module (e.g., central processing unit (CPU) or application processor (AP)) that can perform the corresponding operations by executing one or more software programs stored in a storage module device.

The terms used herein are merely for the purpose of describing particular embodiments and are not intended to limit the scope of other embodiments. As used herein, singular forms may include plural forms as well, unless the context clearly indicates otherwise. Unless defined otherwise, all terms used herein, including technical and scientific terms, have the same meanings as those commonly understood by a person skilled in the art to which the present disclosure pertains. Such terms as those defined in a generally used dictionary may be interpreted to have meanings equal to the contextual meanings in the relevant field of art, and are not to be interpreted to have ideal or excessively formal meanings, unless clearly defined in the present disclosure. In some cases, even a term defined in the present disclosure should not be interpreted to exclude embodiments of the present disclosure.

Hereinafter, a communication device and user terminal is described with reference to the accompanying drawings. In the present disclosure, the term “user” may indicate a person who uses the communication device, a device (e.g., an artificial intelligence device) that uses the communication device, a person who uses the user terminal, or a device that uses the user terminal.

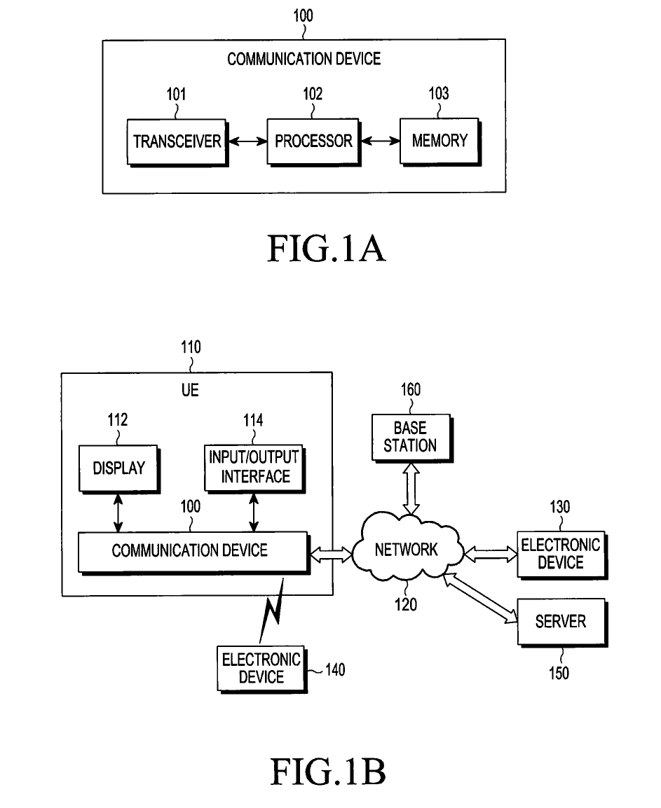

FIG. 1A is a diagram illustrating a communication device, according to an embodiment of the present disclosure.

Referring to FIG. 1A, a communication device 100 includes a transceiver 101, a processor 102, and a memory 103.

The transceiver 101 may configure communication between, for example, the communication device 100 and an external device (for example, a first external electronic device 130, a second external electronic device 140, or a server 150 of FIG. 1B). For example, the transceiver 101 may be connected to a network 120 of FIG. 1B through wireless communication or wired communication, so as to communicate with the external device. The server 150 may include, for example, a communication service provider server to which a user equipment (UE) 110 of FIG. 1B subscribes or a manufacturer server of the UE 110.

According to an embodiment of the present disclosure, the term “transceiver” is interchangeable with various terms, such as a “communication module” and a “communication interface”.

Wireless communication may use at least one of, for example, long term evolution (LTE), LTE-advanced (LTE-A), code division multiple access (CDMA), wideband CDMA (WCDMA), a universal mobile telecommunications system (UMTS), wireless broadband (WiBro), and a global system for mobile communications (GSM), as a cellular communication protocol. Further, wireless communication may include, for example, short-range communication. The short range communication may include at least one of, for example, Wi-Fi, Bluetooth, near field communication (NFC), and a global navigation satellite system (GNSS). The GNSS may include at least one of, for example, a global positioning system (GPS), a global navigation satellite system (Glonass), a Beidou navigation satellite system (hereinafter referred to as “Beidou”), and a European global satellite-based navigation system (Galileo), according to a use area, a bandwidth, or the like.

Wired communication may include, for example, at least one of a universal serial bus (USB), a high definition multimedia interface (HDMI), recommended standard-232 (RS-232), and a plain old telephone service (POTS). The network 120 may include a communication network such as at least one of a computer network (for example, a local area network (LAN) or a wide area network (WAN)), the Internet, and a telephone network.

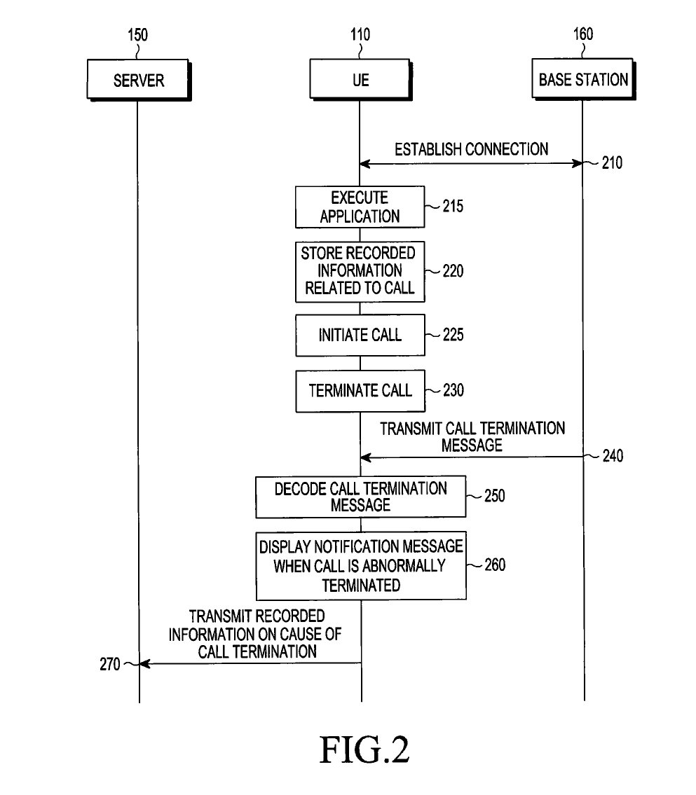

The processor 102 may include a communication processor (CP). According to an embodiment of the present disclosure, the processor 102 may further include one or more of a CPU and an AP. The processor 102 may carry out, for example, operations or data processing related to control and/or communication of at least one other element of the electronic device 100. Particularly, when an abnormal call termination is generated in the UE, the processor 102 may control the output of information on the cause of the abnormal call termination. The various embodiments of the present disclosure will be described in detail based on FIGS. 2 to 4. The term “processor” is interchangeable with various terms, such as “control module”, “control unit”, and “controller”.

The memory 103 may include a volatile memory and/or a non-volatile memory. The memory 103 may store, for example, commands or data related to at least one other element of the communication device 100. According to an embodiment of the present disclosure, the memory 103 may store software and/or a program. The program may include, for example, a kernel, middleware, an application programming interface (API), and/or an application program (or “application”). Although FIG. 1A illustrates that the memory 103 is included in the communication device 100, the memory 103 may be omitted in a process of manufacturing the communication device 100.

The communication device of FIG. 1A may be included in the UE, as illustrated in FIG. 1B.

FIG. 1B is a diagram illustrating a UE including the communication device, according to an embodiment of the present disclosure.

Referring to FIG. 1B, a UE 110 includes the communication device 100, a display unit 112, and an input/output interface 114.

The communication device 100 includes the transceiver 101, the processor 102, and the memory 103 as illustrated in FIG. 1A. When the communication device 100 identifies the generation of an abnormal call termination in the UE 110 in a state where the communication device 100 is connected to a base station 160 for a call with a counterpart UE, the communication device 100 may output information on the cause of the abnormal call termination on the display unit 112 and/or control transmission to the server 150, as described in greater detail below with reference to FIGS. 2 through 4. The display unit 112 may include, for example, a liquid crystal display (LCD), a light emitting diode (LED) display, an organic LED (OLED) display, a micro electro mechanical systems (MEMS) display, and an electronic paper display. The display unit 112 may display, for example, various types of content (for example, text, images, videos, icons, symbols, and the like) to users. The display unit 112 may include a touch screen and may receive, for example, a touch input, a gesture input, a proximity input, or a hovering input using an electronic pen or a user's body part.

The input/output interface 114 may serve as, for example, an interface that may transfer instructions or data, input from the user or another external device, to the other element(s) of the UE 110. Furthermore, the input/output interface 114 may output, to the user or the other external device, instructions or data received from the other element(s) of the UE 110.

According to another embodiment of the present disclosure, the UE 110 may also include a storage module (for example, a memory) or a processor (for example, an AP). Although FIGS. 1A and 1B illustrate that the UE 110 is implemented with separate units, such as the transceiver 101, the processor 102, the memory 103, the display unit 112, and the input/output interface 114, the UE 110 can be implemented in the form of a combination of at least two of the transceiver 101, the processor 102, the memory 103, the display unit 112, and the input/output interface 114. Further, the UE 110 can be implemented with one processor.

An example of the configuration of the UE 110 including the communication device 100 that executes various embodiments of the present disclosure has been described based on FIGS. 1A and 1B in the above description, and a method of controlling the communication device 100 included in the UE 110 according to various embodiments of the present disclosure will be described below with reference to FIGS. 2 to 4.

Various embodiments of the present disclosure relate to a method by which, when the UE 110 identifies that the call with the counterpart UE is abnormally terminated, the UE 110 outputs information on the cause of the call termination, indicating why the call was abnormally terminated to the server 150. When the call is terminated by the base station 160 or when the call termination is detected within the UE 110, the UE 110 may identify that the call with the counterpart UE is abnormally terminated.

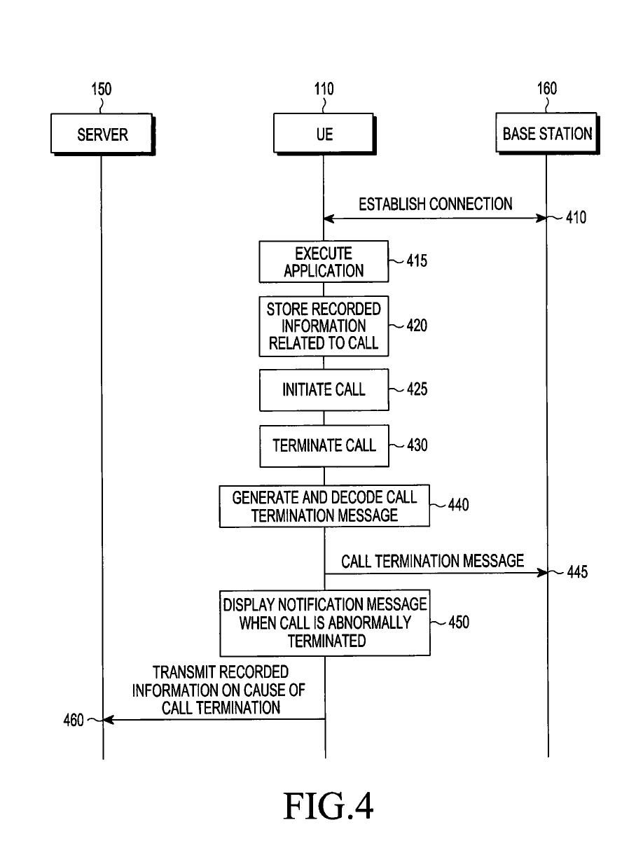

An embodiment in which the UE 110 identifies the abnormal termination of the call with the counterpart UE, when the call is terminated by the base station 160, is described with reference to FIG. 2. An embodiment in which the UE 110 identifies the abnormal termination of the call with the counterpart UE, when the call termination is detected within the UE 110, is described with reference to FIG. 4.

FIG. 2 is a diagram illustrating a method of controlling the UE, according to an embodiment of the present disclosure. FIG. 2 corresponds to reception of a call termination message from the base station 160 by the UE 110, when a call with a counterpart UE is terminated by the base station 160. Although it is described that the UE 110 performs the general operations, such operations are actually controlled by the processor 102 of the communication device 100 included in the UE 110.

Referring to FIG. 2, the UE 110 establishes a connection with the base station 160 for a call with a counterpart UE, in step 210.

Once the connection between the UE 110 and the base station 160 is established, the UE 110 executes an application for transmitting information on the cause of an abnormal call termination to the server 150, in step 215. The UE 110 may perform steps 220 to 270 during the execution of the application.

The UE 110 receives all pieces of recorded information (hereinafter, referred to as log information) transmitted/received for the call with the counterpart UE from the base station 160, and stores the received information in the internal memory 103, in step 220. The log information may be updated while the UE 110 conducts the call with the counterpart UE through the base station 160 and stored in the memory 103. When the call between the UE 110 and the counterpart UE is terminated, log information corresponding to the call between the UE 110 and the counterpart UE may be deleted from the memory 130.

The UE 110 initiates the call with the counterpart UE through the base station 160, in step 225, the call with the counterpart UE 110 terminates, in step 230. The causes of the call termination may include an intended (i.e., normal) call termination by the user of the UE 110 and a call termination by an unintended (i.e., abnormal) cause by the user. The normal call termination may include, for example, a call termination through a selection of a call termination icon by the user. The abnormal call termination may include various cases, for example, a call termination regardless of a user's intention since the counterpart UE is located in a shade area (for example, near a cell edge) and packet transmission/reception is limited, an unstable state of the network 120 between the counterpart UE and the base station 160, an unstable state of the network between the base station 160 and the UE 110, or abnormal handover performance.

When the call is terminated, the UE 110 receives a call termination message (for example, a Call Control (CC)_CAUSE message) according to the call termination, from the base station 160 in an application layer, in step 240. The call termination message may be included in, for example, a call request message (for example, a CC_CALL message). The call termination message is generated by a non access stratum (NAS) of the base station 160 and may include an indicator indicating whether the call is terminated normally or abnormally. The indicator is predefined according to the cause of the call termination between the UE 110 and the base station 160. For example, when the indicator is 0, this means that the call is terminated by a user's request (i.e., the call is normally terminated). Further, when the indicator is 1, this means that the call is terminated according to an abnormal packet drop (i.e., the call is abnormally terminated). When the indicator is 2, this means that the call is terminated due to abnormal performance of a handover (i.e., the call is abnormally terminated). The description of the indicator does not limit embodiments of the present disclosure. The relevant standard content may be applied to the 10 indicator. As an example of the relevant standard content, Table 10.5.123 of 3GPP TS 24.008 may be applied. Table 1 below shows Table 10.5.123 of 3GPP TS 24.008 and may be stored in the internal memory of each of the UE 110 and the base station 160. Accordingly, the base station 160 may identify the cause of the call termination with the UE 110 in the NAS, generate a call termination message including a cause value according to the cause of the call termination identified from Table 1 below, and transmit the generated call termination message to the UE 110.

TABLE 1

| Cause Value | | | | | | | | | | |
|---|---|---|---|---|---|---|---|---|---|---|
| Class | | | Value | | | | Cause | | | |
| 7 | 6 | 5 | 4 | 3 | 2 | 1 | num. | Cause | Diagnostic | Remarks |

| | | | | | | | | | |
|---|---|---|---|---|---|---|---|---|---|
| 0 | 0 | 0 | 0 | 0 | 0 | 1 | 1. | Unassigned (unallocated) number | Note 9 |
| 0 | 0 | 0 | 0 | 0 | 1 | 1 | 3. | No route to destination | Note 9 |
| 0 | 0 | 0 | 0 | 1 | 1 | 0 | 6. | Channel unacceptable | — |
| 0 | 0 | 0 | 1 | 0 | 0 | 0 | 8. | Operator determined barring | — |
| 0 | 0 | 1 | 0 | 0 | 0 | 0 | 16. | Normal call clearing | Note 9 |
| 0 | 0 | 1 | 0 | 0 | 0 | 1 | 17. | User busy | Note 1 |
| 0 | 0 | 1 | 0 | 0 | 1 | 0 | 18. | No user responding | — |
| 0 | 0 | 1 | 0 | 0 | 1 | 1 | 19. | User alerting, no answer | — |
| 0 | 0 | 1 | 0 | 1 | 0 | 1 | 21. | Call rejected | Note 9 - user supplied |
| | | | | | | | | | diagnostic (note 4) |
| 0 | 0 | 1 | 0 | 1 | 1 | 0 | 22. | Number changed | New destination (note 5) |
| 0 | 0 | 1 | 1 | 0 | 0 | 0 | 24. | Call rejected due to feature at the | — |
| | | | | | | | | destination | |
| 0 | 0 | 1 | 1 | 0 | 0 | 1 | 25. | Pre-emption | |
| 0 | 0 | 1 | 1 | 0 | 1 | 0 | 26. | Non selected user clearing | — |
| 0 | 0 | 1 | 1 | 0 | 1 | 1 | 27. | Destination out of order | — |
| 0 | 0 | 1 | 1 | 1 | 0 | 0 | 28. | Invalid number format (incomplete | — |
| | | | | | | | | number) | |
| 0 | 0 | 1 | 1 | 1 | 0 | 1 | 29. | Facility rejected | Note 1 |
| 0 | 0 | 1 | 1 | 1 | 1 | 0 | 30. | Response to STATUS ENQUIRY | — |
| 0 | 0 | 1 | 1 | 1 | 1 | 1 | 31. | Normal, unspecified | — |
| 0 | 1 | 0 | 0 | 0 | 1 | 0 | 34. | No circuit/channel available | Note 1 |
| 0 | 1 | 0 | 0 | 1 | 1 | 0 | 38. | Network out of order | — |
| 0 | 1 | 0 | 1 | 0 | 0 | 1 | 41. | Temporary failure | — |
| 0 | 1 | 0 | 1 | 0 | 1 | 0 | 42. | Switching equipment congestion | — |
| 0 | 1 | 0 | 1 | 0 | 1 | 1 | 43. | Access information discarded | Discarded information |
| | | | | | | | | | element identifiers (note 6) |
| 0 | 1 | 0 | 1 | 1 | 0 | 0 | 44. | requested circuit/channel not available | — |
| 0 | 1 | 0 | 1 | 1 | 1 | 1 | 47. | Resources unavailable, unspecified | — |
| 0 | 1 | 1 | 0 | 0 | 0 | 1 | 49. | Quality of service unavailable | Note 9 |
| 0 | 1 | 1 | 0 | 0 | 1 | 0 | 50. | Requested facility not subscribed | Note 1 |
| 0 | 1 | 1 | 0 | 1 | 1 | 1 | 55. | Incoming calls barred within the CUG | Note 1 |
| 0 | 1 | 1 | 1 | 0 | 0 | 1 | 57. | Bearer capability not authorized | Note 3 |
| 0 | 1 | 1 | 1 | 0 | 1 | 0 | 58. | Bearer capability not presently available | Note 3 |
| 0 | 1 | 1 | 1 | 1 | 1 | 1 | 63. | Service or option not available, | — |
| | | | | | | | | unspecified | |
| 1 | 0 | 0 | 0 | 0 | 0 | 1 | 65. | Bearer service not implemented | Note 3 |

Referring back to FIG. 2, the UE 110 decodes the call termination message received from the base station 160 in the application layer, and determines the cause of the call termination, in step 250. For example, the UE 110 may determine that the call is normally terminated when the indicator included in the call termination message is 0, and may determine that the call is abnormally terminated when the indicator is 1. In another example, the UE 110 identifies the cause value included in the call termination message by decoding the call termination message and detects the cause of the call termination according to the identified cause value based on Table 1 above.

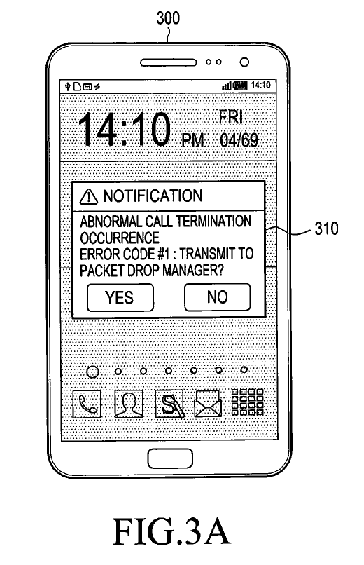

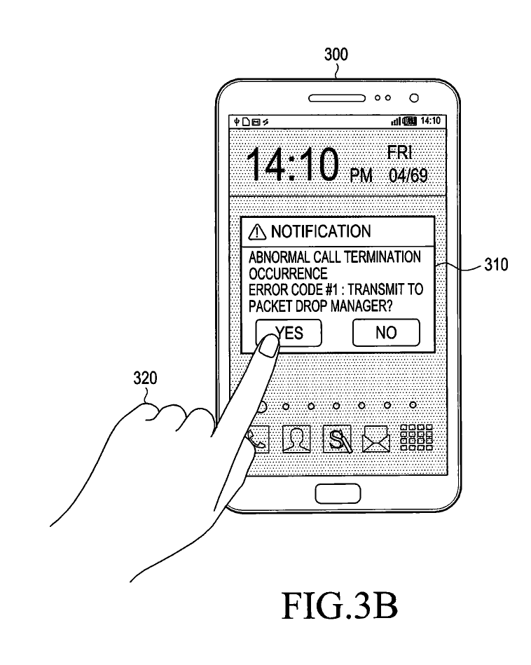

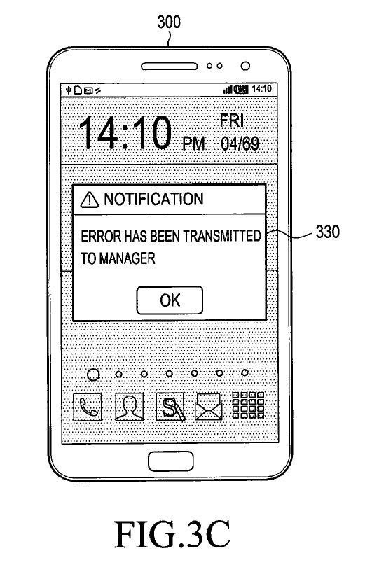

When it is determined that the call is abnormally terminated, the UE 110 displays a notification message (for example, a notification message 310 of FIG. 3A) for the cause of the abnormally terminated call on the display unit 112, in step 260. The notification message may include, for example, the cause of the abnormally terminated call, as illustrated in FIG. 3A. When it is determined that the call is normally terminated, the UE 110 may proceed to step 270 without displaying the notification message according to initial settings.

The UE 110 transmits recorded information on the cause of the call termination to the server 150, in step 270. The UE 110 may transmit, to the server 150, log information related to the cause of the call termination from among the pieces of log information stored in the internal memory 103.

When the UE 110 detects a request event requesting transmission of the information on the cause of the call termination to the server 150, as illustrated in FIGS. 3A to 3C, the UE 110 transmits information on the cause of the call termination to the server 150, in step 270.

FIGS. 3A to 3C are diagrams illustrating an operation in which, when a call is abnormally terminated, a notification message is displayed and information on the cause of the abnormally terminated call is transmitted to the server through the notification message, according to an embodiment of the present disclosure.

As illustrated in FIG. 3A, the notification message 310 is displayed on the display unit 112 of a UE 300. As illustrated in FIG. 3B, the UE 300 may detect a transmission request event according to the user's input through the display unit 112. When the transmission request event is detected, the UE 300 transmits information on the cause of the abnormally terminated call to the server 150, and displays a transmission completion message 330 informing of the completion of the transmission, as illustrated in FIG. 3C.

FIG. 4 is a diagram illustrating a method of controlling the UE, according to another embodiment of the present disclosure. FIG. 4 corresponds to the generation of a call termination message by the UE 110 when a call with a counterpart UE is terminated by the UE 110.

Referring to FIG. 4, the UE 110 establishes a connection with the base station 160 for the call with the counterpart UE, in step 410. While the connection between the UE 110 and the base station 160 is established, the UE 110 executes an application for transmitting information on the cause of an abnormal call termination to the server 150, in step 415. The UE 110 may perform steps 420 to 460 during the execution of the application.

The UE 110 receives all pieces of log information transmitted/received for the call with the counterpart UE from the base station 160 and stores the received log information in the internal memory 103, in step 420. As described above, the log information stored in the internal memory 130 may be updated or deleted according to transmission/reception of data for the call between the UE 110 and the base station 160.

The UE 110 initiates the call with the counterpart UE through the base station 160, in step 425, and the call with the counterpart UE is terminated, in step 430.

When the call is terminated by the UE 110, the UE 110 generates a call termination message and decodes the generated call termination message, in step 440. Further, the UE 110 transmits the generated call termination message to the base station 160, in step 445.

The call termination by the UE 110 may include various cases, for example, a call termination through a selection of a call termination icon by the user of the UE 110 and a call termination regardless of a user's intention since the UE 110 is located in a shade area, and thus, packet transmission/reception is limited. The UE 110 may generate the call termination message through the same method as that of the base station 160 in the embodiment described with reference to FIG. 2. That is, the UE 110 may generate a call termination message that includes a predefined indicator according to the cause of the call termination. For example, the UE 110 may generate a call termination message including a cause value according to the cause of the call termination based on Table 1 above.

When it is determined that the call is abnormally terminated based on a result of the decoding of the call termination message, the UE 110 displays a notification message (for example, the notification message 310) for the cause of the abnormally terminated call on the display unit 112, in step 450. Since the example of displaying the notification message 310 on the display unit 112 has been described in detail based on FIGS. 3A to 3B, a detailed description thereof will be omitted.

When it is determined that the call is abnormally terminated, the UE 110 may proceed to step 270 without displaying the notification message according to initial settings.

The UE 110 transmits recorded information on the cause of the call termination to the server 150, in step 460. The UE 110 may transmit, to the server 150, log information related to the cause of the call termination from among all pieces of log information stored in the internal memory 103.

According to embodiments of the present disclosure, the UE 110 identifies the cause of the termination of the call with the counterpart UE in the application layer, and directly transmits information on the cause of the call termination to the server 150, so as to directly receive feedback information from the server 150 if the call is abnormally terminated. Accordingly, when embodiments of the present disclosure are applied to the UE 110, the UE 110 can provide a highly reliable service to the user. Since the server 150 directly receives information on the cause of the call termination from the UE 110, costs and time incurred in order to receive the information on the cause of the call termination can be reduced. Further, since the server 150 may receive log information on a call with another UE from a plurality of UEs, detailed debugging can be performed, and it is not required to configure an additional device and developer for a call test. In addition, the base station 160 may receive a call termination message from the UE 110, and thus, the base station 160 may determine a performance of the network 120 and a performance (e.g., reliability) of the UE 110 with respect to the call.

The term “module”, as used herein, may refer to a unit including one of or a combination of two or more of hardware, software, and firmware. The term “module” may be interchangeably used with the terms “unit,” “logic,” “logical block,” “component,” and “circuit.” A module may be a minimum unit or a portion of an integrated component. A module may be a minimum unit or a portion thereof performing one or more functions. A module may be implemented mechanically or electronically. For example, a module may include at least one of an application-specific integrated circuit (ASIC) chip, field-programmable gate arrays (FPGAs), and a programmable-logic device performing certain operations already known or to be developed.

At least a part of a device (for example, modules or functions thereof) or a method (for example, operations), according to an embodiment of the present disclosure, may be implemented with a command stored in a computer-readable storage medium in the form of a programming module. When the command is executed by a processor (for example, the processor 102 of FIG. 1A), the one or more processors may perform a function corresponding to the command. The computer-readable storage medium may be, for example, the memory 103 of FIG. 1A.

The computer readable recording medium may include a hard disk, a floppy disk, magnetic media (e.g., magnetic tape), optical media (e.g., a compact disc read only memory (CD-ROM) or a digital versatile disc (DVD)), magneto-optical media (e.g., a floptical disk), and a hardware device (e.g., a read only memory (ROM), a random access memory (RAM), or a flash memory). Further, the program instructions may include a machine language code created by a complier and a high-level language code executable by a computer using an interpreter. The foregoing hardware device may be configured to be operated as at least one software module to perform an operation of the present disclosure, or vice versa.

Modules or programming modules, according to embodiments of the present disclosure, may include one or more of the foregoing elements, may have some of the foregoing elements omitted, or may include additional elements. Operations performed by the modules, the programming modules, or other elements may be executed in a sequential, parallel, repetitive, or heuristic manner. Also, some of the operations may be executed in a different order, may be omitted, or may include additional operations. Embodiments disclosed herein are provided to assist in the understanding of disclosed technical matters, and are not intended to limit the scope of the technology described herein. Thus, the scope of the present disclosure should be construed as including any change or various other embodiments based on the technical spirit of the present disclosure.

The present disclosure may be utilized in conjunction with the manufacture of integrated circuits, chip sets, or system-on-chips (SoCs). One skilled in the art would know how to dice wafers and package die to produce integrated circuits. Integrated circuits so manufactured are considered part of this disclosure.

While the present disclosure has been shown described with reference to certain embodiments thereof, it will be understood by those skilled in the art that various changes in form and detail may be made therein without departing from the spirit and scope of the present disclosure as defined by the appended claims.

What is claimed is:

1. A communication device comprising:
a transceiver; and
a processor electrically connected to the transceiver,
wherein the processor is configured to store log information related to a call, determine whether the call is abnormally terminated, and output information on a cause of call termination when the call is abnormally terminated, and
wherein the call is abnormally terminated when the call termination does not occur through a termination request of a user.

2. The communication device of claim 1, wherein the processor is further configured to acquire and decode a call termination message related to the call termination.

3. The communication device of claim 2, wherein the call termination message is acquired by an application layer of the communication device.

4. The communication device of claim 2, wherein the processor is further configured to determine that the call is abnormally terminated when the decoded call termination message includes information indicating that the call is abnormally terminated, identify the cause of the call termination corresponding to the information indicating that the call is abnormally terminated, and output the information on the cause of the call termination.

5. The communication device of claim 2, wherein the call termination message is received from a base station connected to the communication device.

6. The communication device of claim 2 wherein the call termination message is generated by the processor.

7. The communication device of claim 4, further comprising a display unit configured to receive an input requesting transmission of at least a portion of the log information relating to the cause of the call termination.

8. The communication device of claim 7, wherein, when the input is detected through the display unit, the processor is further configured to control the transceiver to transmit the at least a portion of the log information relating to the cause of the call termination to the server.

9. The communication device of claim 4, wherein the processor is further configured to control the display unit to display the cause of the call termination.

10. A method of controlling a communication device, the method comprising:
storing log information related to a call;
determining whether the call is abnormally terminated; and
outputting information on a cause of call termination when the call is abnormally terminated,
wherein the call is abnormally terminated when the call termination does not occur through a termination request of a user.

11. The method of claim 10, further comprising acquiring and decoding a call termination message related to the call termination.

12. The method of claim 11, wherein the call termination message is acquired by an application layer of the communication device.

13. The method of claim 12, wherein determining whether the call is abnormally terminated comprises determining that the call is abnormally terminated when the decoded call termination message includes information indicating that the call is abnormally terminated.

14. The method of claim 13, wherein outputting the information on the cause of the call termination comprises identifying the cause of the call termination corresponding to the information indicating that the call is abnormally terminated, and outputting information on the cause of the call termination.

15. The method of claim 11, wherein the call termination message is received from a base station connected to the communication device.

16. The method of claim 11, wherein the call termination message is generated by the processor.

17. The method of claim 10, further comprising receiving an input requesting transmission of at least a portion of the log information related to the cause of the call termination.

18. The method of claim 17, further comprising, when the user input is detected, transmitting the at least a portion of the log information related to the cause of the call termination to the server.

19. A method of controlling a communication device, the method comprising:
storing log information related to a call established with another communication device;
receiving a call termination message upon termination of the call;
determining whether the call was normally terminated from an indicator of the call termination message;
transmitting a least a portion of the log information related to a cause of call termination to a server, when the call was normally terminated;
when the call was not normally terminated, outputting information on the cause of the call termination and transmitting the at least a portion of the log information related to the cause of the call termination to the server,
wherein the call is normally terminated through a termination request of a user of the communication device or the other communication device.

20. The method of claim 19, wherein determining whether the call was normally terminated comprises:
decoding the call termination message;
identifying the indicator from the decoded call termination message;
determining whether the call was normally terminated based on predefined values or a table corresponding to the indicator.
